(19) United States
(12) Patent Application Publication
(10) Pub. No.: US 2025/0203567 A1
(43) Pub. Date: Jun. 19, 2025

(54) METHOD, APPARATUS AND COMPUTER PROGRAM

(71) Applicant: Nokia Technologies Oy, Espoo (FI)

(72) Inventors: Ganesh VENKATRAMAN, Oulu (FI); Muhammad Ikram ASHRAF, Espoo (FI); Dick CARRILLO MELGAREJO, Lappeenranta (FI)

(73) Assignee: Nokia Technologies Oy, Espoo (FI)

(21) Appl. No.: 18/977,232

(22) Filed: Dec. 11, 2024

(30) Foreign Application Priority Data
Dec. 14, 2023 (GB) 2319209.9

(51) Int. Cl. H04W 64/00; H04W 24/10

(52) U.S. Cl. CPC H04W 64/00; H04W 24/10

(57) ABSTRACT

There is provided a method, computer program, and apparatus for performing: determining, based on at least one condition of a reporting apparatus, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps; signalling, to the reporting apparatus, the first measurement reporting configuration and a request for the reporting apparatus to select a second measurement reporting configuration to be used by the reporting apparatus based on the first measurement reporting configuration; receiving, from the reporting apparatus, a measurement report according to the second measurement reporting configuration; and using at least one value comprised in the measurement report as an input to an artificial intelligence and/or machine learning model.

### FIELD

The present application relates to a method, apparatus, system and computer program and in particular but not exclusively to a location management function that uses at least one value comprised in a measurement report as an input to an artificial intelligence and/or machine learning model.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to a first aspect, there is provided an apparatus for a location management function, the apparatus comprising means for performing: determining, based on at least one condition of a reporting apparatus, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps; signalling, to the reporting apparatus, the first measurement reporting configuration and a request for the reporting apparatus to select a second measurement reporting configuration to be used by the reporting apparatus based on the first measurement reporting configuration; receiving, from the reporting apparatus, a measurement report according to the second measurement reporting configuration; and using at least one value comprised in the measurement report as an input to an artificial intelligence and/or machine learning model.

According to a second aspect, there is provided an apparatus for a location management function, the apparatus comprising: at least one processor; and at least one memory comprising code that, when executed by the at least one processor, causes the apparatus to perform: determining, based on at least one condition of a reporting apparatus, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps; signalling, to the reporting apparatus, the first measurement reporting configuration and a request for the reporting apparatus to select a second measurement reporting configuration to be used by the reporting apparatus based on the first measurement reporting configuration; receiving, from the reporting apparatus, a measurement report according to the second measurement reporting configuration; and using at least one value comprised in the measurement report as an input to an artificial intelligence and/or machine learning model.

According to a third aspect, there is provided a method for an apparatus for a location management function, the method comprising: determining, based on at least one condition of a reporting apparatus, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps; signalling, to the reporting apparatus, the first measurement reporting configuration and a request for the reporting apparatus to select a second measurement reporting configuration to be used by the reporting apparatus based on the first measurement reporting configuration; receiving, from the reporting apparatus, a measurement report according to the second measurement reporting configuration; and using at least one value comprised in the measurement report as an input to an artificial intelligence and/or machine learning model.

According to a fourth aspect, there is provided an apparatus for a location management function, the apparatus comprising: determining circuitry for determining, based on at least one condition of a reporting apparatus, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps; signalling circuitry for signalling, to the reporting apparatus, the first measurement reporting configuration and a request for the reporting apparatus to select a second measurement reporting configuration to be used by the reporting apparatus based on the first measurement reporting configuration; receiving circuitry for receiving, from the reporting apparatus, a measurement report according to the second measurement reporting configuration; and using circuitry for using at least one value comprised in the measurement report as an input to an artificial intelligence and/or machine learning model.

In all of the above aspects, the using at least one value comprised in the measurement report as an input to an artificial intelligence and/or machine learning model may further comprise performing: identifying, from the received measurement report, the second measurement reporting configuration; reconstructing at least one of a channel impulse response or a power delay profile or a delay profile using the second measurement reporting configuration; and using the reconstructed at least one of a channel impulse response or a power delay profile or a delay profile as an input to the artificial intelligence and/or machine learning model.

The maximum frequency of reporting measurements may define a maximum frequency of periodic measurement reports, and/or a maximum frequency of event-based reporting.

The first measurement reporting configuration may configure the reporting apparatus to report measurements periodically and/or using event-based criteria.

The first measurement reporting configuration may comprise a plurality of third measurement reporting configurations, each of said third measurement reporting configurations relating to a respective port.

The first measurement reporting configuration may comprise a plurality of third measurement reporting configurations, the third measurement reporting configurations relating to a same plurality of ports.

The measurement report may comprise an indication of the number of windows used for reporting, and, for each window, a location of a start point for said window, a width of said window, and locations of valid taps within said window.

The measurement report may further comprise, for each window, at least one of: phase information of valid taps being reported in said window, amplitude information of valid taps being reported in said window, and/or an energy of valid taps being reported in said window.

The measurement report may further comprise, for each window, an indication of a threshold used for identifying valid taps comprised in said window.

The reporting apparatus may comprise a user equipment, and the signalling may comprise location positioning protocol signalling.

The reporting apparatus may comprise an access network node, and the signalling may comprise new radio positioning protocol A.

The at least one condition of the reporting apparatus may comprise at least one of: a number of antenna ports, an available bandwidth available to the reporting apparatus, a maximum number of taps to be reported by the reporting apparatus, a maximum number of transmission reception points to be reported on by the reporting apparatus, or a type of measurements to be reported.

The determining the first measurement configuration may be based on at least one additional condition that comprises at least one of: a cell identifier to be reported on, a scenario to be reported on, or an indication of a dataset quality to be used for training.

According to a fifth aspect, there is provided an apparatus for a reporting apparatus, the apparatus comprising means for performing: receiving, from a location management function, LMF, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps; receiving, from the LMF, a request for the reporting apparatus to select a second measurement reporting configuration to be used by the reporting apparatus based on the first measurement reporting configuration; selecting the second measurement reporting configuration based on the first measurement reporting configuration; measuring a state of a channel between the reporting apparatus and another apparatus; and signalling, to the LMF, a measurement report according to the second measurement reporting configuration, the measurement report comprising values based on the measured state of the channel.

According to a sixth aspect, there is provided an apparatus for a reporting apparatus, the apparatus comprising: at least one processor; and at least one memory comprising code that, when executed by the at least one processor, causes the apparatus to perform: receiving, from a location management function, LMF, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps; receiving, from the LMF, a request for the reporting apparatus to select a second measurement reporting configuration to be used by the reporting apparatus based on the first measurement reporting configuration; selecting the second measurement reporting configuration based on the first measurement reporting configuration; measuring a state of a channel between the reporting apparatus and another apparatus; and signalling, to the LMF, a measurement report according to the second measurement reporting configuration, the measurement report comprising values based on the measured state of the channel.

According to a seventh aspect, there is provided a method for an apparatus for a reporting apparatus, the method comprising: receiving, from a location management function, LMF, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps; receiving, from the LMF, a request for the reporting apparatus to select a second measurement reporting configuration to be used by the reporting apparatus based on the first measurement reporting configuration; selecting the second measurement reporting configuration based on the first measurement reporting configuration; measuring a state of a channel between the reporting apparatus and another apparatus; and signalling, to the LMF, a measurement report according to the second measurement reporting configuration, the measurement report comprising values based on the measured state of the channel.

According to an eighth aspect, there is provided an apparatus for a reporting apparatus, the apparatus comprising: receiving circuitry for receiving, from a location management function, LMF, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps; receiving circuitry for receiving, from the LMF, a request for the reporting apparatus to select a second measurement reporting configuration to be used by the reporting apparatus based on the first measurement reporting configuration; selecting circuitry for selecting the second measurement reporting configuration based on the first measurement reporting configuration; measuring circuitry for measuring a state of a channel between the reporting apparatus and another apparatus; and signalling circuitry for signalling, to the LMF, a measurement report according to the second measurement reporting configuration, the measurement report comprising values based on the measured state of the channel.

The maximum frequency of reporting measurements may define a maximum frequency of periodic measurement reports, and/or a maximum frequency of event-based reporting.

The first measurement reporting configuration may configure the reporting apparatus to report measurements periodically and/or using event-based criteria.

The first measurement reporting configuration may comprise a plurality of third measurement reporting configurations, each of said third measurement reporting configurations relating to a respective port, wherein the second measurement reporting configuration is selected from the third measurement configurations based on the port used for channel state measurement.

The first measurement reporting configuration may comprise a plurality of third measurement reporting configurations, the third measurement reporting configurations relating to a same plurality of ports.

The measurement report may comprise an indication of the number of windows used for reporting, and, for each window, a location of a start point for said window, a width of said window, and locations of valid taps within said window.

The measurement report may further comprise, for each window, at least one of: phase information of valid taps being reported in said window, amplitude information of valid taps being reported in said window, and/or an energy of valid taps being reported in said window.

The measurement report may further comprise, for each window, an indication of a threshold used for identifying valid taps comprised in said window.

The reporting apparatus may comprise a user equipment, and the signalling may comprise location positioning protocol signalling.

The reporting apparatus may comprise an access network node, and the signalling may comprise new radio positioning protocol A signalling.

The second reporting configuration may be selected to comprise a window size that is based on the measured channel state.

The second reporting configuration may be selected to comprise a reporting periodicity that is based on at least one of a capability of the reporting apparatus, a power state of the reporting apparatus, a bandwidth available to the reporting apparatus, and/or a number of ports.

The first reporting configuration may be comprised in specific functionality that comprises a set of configurations comprising at least a condition of the reporting apparatus and/or an additional condition.

The at least one condition of the reporting apparatus may comprise at least one of: a number of antenna ports, an available bandwidth available to the reporting apparatus, a maximum number of taps to be reported by the reporting apparatus, a maximum number of transmission reception points to be reported on by the reporting apparatus, or a type of measurements to be reported.

The at least one additional condition that comprises at least one of: a cell identifier to be reported on, a scenario to be reported on, or an indication of a dataset quality to be used for training.

Any of the above-mentioned aspects may further comprise performing selecting a threshold amount x dB for identifying the valid taps, wherein the valid taps are those sample values that are measured to be within x dB of a maximum sample value.

Any of the above-mentioned aspects may further comprise performing selecting a threshold amount ydB for identifying the valid taps, wherein the valid taps are those sample values that are measured to be ydB above an average channel energy for the channel whose state is being measured.

According to an aspect, there is provided a non-transitory computer readable medium comprising program instructions that, when executed by an apparatus, cause the apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIGS. 4 to 5B illustrate example artificial intelligence and/or machine learning input and output;

FIGS. 6A to 6C illustrate channel state information as a function of taps;

FIGS. 7A to 7B illustrate example signalling between apparatus described herein;

FIG. 8 illustrates applying a window mechanism to delay path reporting;

FIG. 9 illustrates an example reporting structure;

FIG. 10 illustrates an example table;

FIGS. 11A-1, 11A-2, 11A-3, 11B-1, 11B-2, 11B-3, 11C-1, 11C-2, 11C-3, 11D-1, 11D-2, and 11D-3 illustrate example windowing size for different power delay path measurement results;

FIG. 12 illustrates applying a window mechanism to delay path reporting;

FIGS. 13 to 15 illustrate example reporting structures; and

FIGS. 16 to 17 illustrate example operations that may be performed by apparatus described herein.

### DETAILED DESCRIPTION

In general, the following relates to providing an efficient reporting mechanism for reporting measurement information to be used by a location management function (LMF) when determining a location of an apparatus. The LMF may cause the measurement information to be used as an input to a trained artificial intelligence (AI) model and/or machine learning (ML) model, where the trained AI model and/or ML model is caused to output a location of an apparatus when provided with at least said input. The measurement information may be reported by a UE and/or an access network node (such as, for example, a gNB).

In particular, the following discloses an LMF that can select set of configuration parameters to be used by a reporting apparatus (e.g., a UE and/or access network node) when reporting channel state information. The set of configuration parameters (e.g., maximum window size, maximum frequency for reporting, maximum number of windows, etc.) may be selected based on the reporting apparatus' capabilities and/or a current bandwidth available to the reporting apparatus. The reporting apparatus may then use information about the current channel state (e.g., the interference currently being experienced between the UE and the access network node) to select a reporting configuration that will actually be used for reporting channel state information from the set of configuration parameters. The reporting apparatus subsequently provides measurement information indicating the current channel state by reporting the measurement result to the LMF using the selected reporting configuration. The LMF may use the provided measurement information as an input to an artificial intelligence and/or machine learning model for determining a location of a UE.

In more detail, the following discloses a mechanism that can be used for reducing the amount of overhead used for reporting channel state information (such as, for example, delayed path (DP) information, power delayed path (PDP) information, and/or channel impulse response (CIR) information) measured during a measurement duration from a reporting apparatus to the LMF, relative to current mechanisms.

This may be achieved by causing the DP information to be transmitted using a window-based mechanism.

Currently, DP information is transmitted using a bitmap that uses “one” values for representing valid taps (e.g., those measurement samples that are determined to be within a threshold amount of a maximum measurement sample) and “zero” values for representing invalid taps (e.g., those measurement samples that are determined to be outside of the threshold range of the maximum measurement sample).

With a window-based mechanism, areas of activity in the DP information (e.g., areas of the signal that comprise bit values of one) are identified and defined as windows. It is understood that there may be one or more windows. The first value of each defined window may comprise a “one” value in a DP bitmap, and the duration of each defined window may last a certain number of taps. The certain number may be predefined by the LMF and/or selected by the UE and/or access network node. The start location of each window may be associated with a respective offset from an initial tap value. Where there are multiple windows, each window may have the same duration as each other (e.g., the same number of taps), or a different duration to each other (e.g., different numbers of taps).

The DP information may subsequently be reported to an LMF using, for each window, a bitmap that identifies the location of valid taps and invalid taps within the window, and a start location of that window relative to a predefined reference point (e.g., a predefined time and/or a predefined tap). Where applicable, a length of the window may also be indicated for each window. This window-based mechanism may be useful as there are a potentially large number of invalid taps within a measurement duration that are not signalled (e.g., that are not explicitly signalled) as they fall outside the duration of the window(s). This means that the valid tap information may be transmitted using fewer bits than when the full DP report (e.g., that identifies the validity of each tap within the measurement duration) is signalled.

Further, the window-based DP report may be accompanied by phase and/or amplitude information, which may be used for reconstructing at least some part of CIR and/or PDP. Reconstructed CIR and/or PDP may also or alternatively be used as an input to a trained AI model and/or trained ML model for determining a location of an apparatus. This is described further below.

By allowing the reporting apparatus to determine what reporting configuration to use (out of a range of reporting configurations defined by the above-mentioned maximum reporting configuration), the reporting apparatus may efficiently report measurement information for use in determining a location of a user equipment.

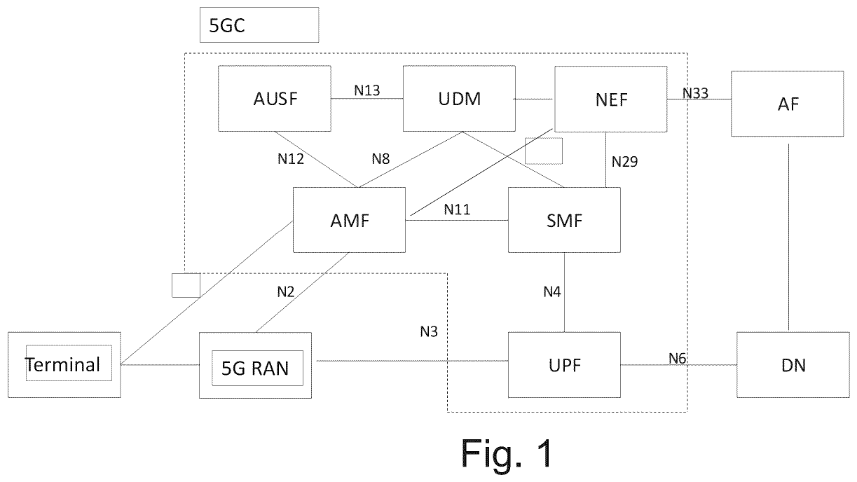

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may be comprised by a terminal or user equipment (UE), a 5G radio access network (5GRAN) or next generation radio access network (NG-RAN), a 5G core network (5GC), one or more application function (AF) and one or more data networks (DN).

The 5G-RAN may comprise one or more gNodeB (GNB) or one or more gNodeB (GNB) distributed unit functions connected to one or more gNodeB (GNB) centralized unit functions.

The 5GC may comprise the following entities: Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); and Session Management Function (SMF). FIG. 1 also shows the various interfaces (N1, N2 etc.) that may be implemented between the various elements of the system.

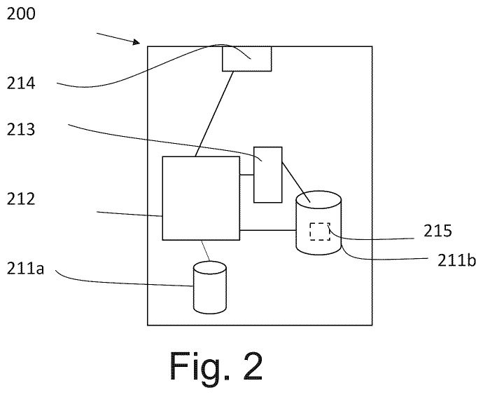

FIG. 2 illustrates an example of a control apparatus 200 for controlling a function of the 5GRAN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some embodiments, each function of the 5GRAN or the 5GC comprises a control apparatus 200. In alternative embodiments, two or more functions of the 5GRAN or the 5GC may share a control apparatus.

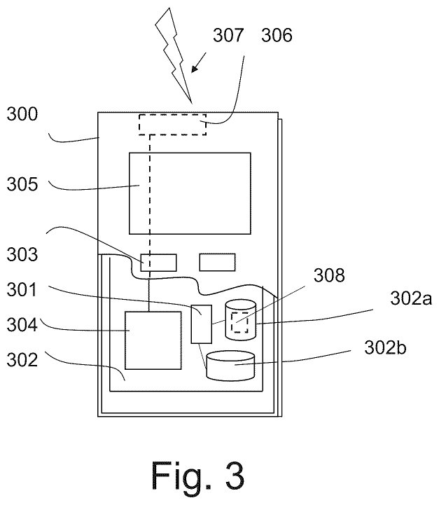

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

Determining a location of an apparatus (e.g., a UE and/or a mobile access network node) is important for several different reasons. For example, the location of a UE may affect the services available to a UE, what physical resources (e.g., time and/or frequency resources) are available to the UE for communicating via a network access node (such as a gNB), handover decisions, etc.

In order to determine an apparatus' location, 3GPP has previously introduced specific functionality in the core network core that can be used for determining (or otherwise causing determining) the apparatus' location. This functionality is referred to as a location management function (LMF).

As a large amount of data may be available for determining the apparatus' location, 3GPP has been considering deploying an artificial learning (AI) and/or machine learning (ML) mechanism for determining the apparatus' location (see, for example, 3GPP TR 38.843). These AI and/or ML (AL/ML) mechanisms may be used for “direct AI/ML positioning (in which the AI/ML model output comprises a determined location for the apparatus), and/or for “AI/ML assisted positioning” (in which the AI/ML model output comprises either a new measurement for use in determining the apparatus' location and/or an enhancement of an existing measurement for use in determining the apparatus' location (e.g., line-of-sight/non-line-of-light identification, timing and/or angle of measurement, likelihood of measurement, etc.).

The following relates to direct AI/ML positioning, in which the AI/ML model providing the output is located at a network function (such as the LMF) and in which at least one input to the model comprises a measurement value determined by the apparatus whose location is to be determined (e.g., UE) and/or a network access node (e.g., a gNB).

In general, AI/ML mechanisms comprise at least one of a data collection process, a training process, or an inference process.

During a data collection process, data is collected by at least one of a network node, a management entity, or a UE for the purpose of AI/ML model training, data analytics and/or inference processes.

During a training process, an AI/ML model is trained (e.g., to learn an input/output relationship) in a data driven model to obtain a trained AI/ML model for an inference process.

During an inference process, a trained AI/ML model is used to produce a set of outputs based on a set of inputs. Stated differently, the trained AI/ML model is configured to use the learnt input/output relationship to convert a provided input to the trained AI/ML model into an output during the inference process.

Recently, 3GPP has agreed to use indications of current channel conditions when determining a location of an apparatus. A current channel condition (e.g., state, channel state, etc.) may be determined using measurements performed by an access network node (e.g., by a gNB performing measurements on a sounding reference signal (SRS) transmitted by a UE), and/or using measurements performed by a UE (e.g., by performing measurements on a positioning reference signal (PRS) transmitted by an access network node). For clarity and brevity, it is understood that where the below refers only to operations performed by a UE when reporting measurement information to an LMF, that these operations may also be performed by an access network node (where the measurement information instead refers to measurement information pertaining to measurements performed on an SRS instead of to measurements performed on a PRS).

Depending on the model location, channel state information (discussed further below in relation to channel impulse response (CIR), power delay path (PDP), and/or delay path (DP), discussed further below) is fed back to the respective nodes that causes the model to be deployed.

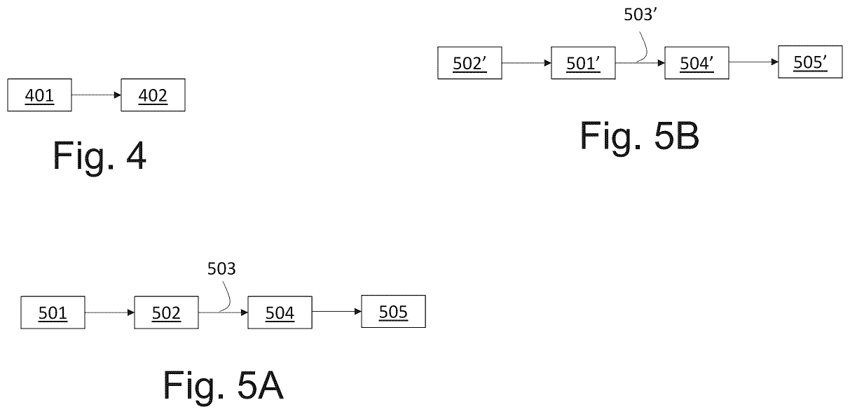

This is illustrated in FIGS. 4 to 5A and 5B.

In more detail, when the channel state information is to be reported to a network entity (e.g., a radio access network entity, such as a gNB, and/or a location management function (LMF)) for use as model input for the propose of training and inference as illustrated in FIG. 4.

FIG. 4 illustrates measurement information 401 being input as an inference output to a direct AI/ML positioning algorithm 402. A UE position is output by the direct AI/ML positioning algorithm 402 using the measurement information 401. The measurement information may comprise channel state information.

FIGS. 5A and 5B illustrates two respective positioning scenarios in which the AI/ML model resides at the LMF, and uses feedback from a UE (FIG. 5A) or an access network node (e.g., a gNB, FIG. 5B) as an input. Among other feedback information, CIR, PDP, and DP were agreed to be a possible feedback information.

FIG. 5A illustrates an example in which a UE 502 performs a measurement on a downlink positioning reference signal (PRS) transmitted by a transmission reception point 501 for use in determining a location of the UE 502. The result of this positioning measurement 503 is provided to an LMF 504 for use as an input to an AI/ML model for determining the location of the UE 502. The AI/ML model outputs a position 505 that indicates the location of the UE 502.

FIG. 5B illustrates an example in which a gNB 501′ performs a measurement on a positioning reference signal (PRS) transmitted by a UE 502′ for use in determining a location of the UE 502′. The result of this positioning measurement 503′ is provided to an LMF 504′ for use as an input to an AI/ML model for determining the location of the UE 502′. The AI/ML model outputs a position 505′ that indicates the location of the UE 502′.

Although there are several existing parameters that indicate a state of channel and so may be used for as channel state information (such as, for example, a reference signal received power (RSRP), a reference signal received path power (RSRPP), and/or reference signal time difference (RSTD)), according to the RAN1 AI/ML for air interface study (Rel-18), at least one of a channel impulse response (CIR), a power delay profile (PDP), or a delay profile (DP) may be used as an input to AI/ML models for determining a location of an apparatus. These are described further below.

The Channel Impulse Response (CIR) is a concept used to describe the behavior of a communication channel. The CIR is a mathematical function that describes how a signal travels through a communication channel. In more detail, the CIR is a mathematical function that describes the response of a communication channel to a short pulse or impulse. The channel impulse response represents a channel's time-domain response to a channel's response to an impulse, and it can be used to predict how a signal will be distorted as it travels through the channel. CIR is often expressed as a sequence of values that correspond to different time instants. These values are called taps, and they represent the amplitude and phase of the channel's response at each time instant. The CIR can be measured using various techniques, depending on the type of communication channel and the equipment available. In general, the CIR is measured by transmitting a short pulse or impulse through the channel and observing the response at the receiver. CIR comprises a list of measurements where each measurement contains the information of: (a) delay, (b) power and (c) phase.

The power delay profile (PDP) is a representation of the power of the received signal as a function of its delay, and characterizes the time-varying channel impulse response between a transmitter and receiver. The PDP may thus be said to quantify the strength and timing of the different propagation paths. In a Power Delay Profile plot, the signal power of each multipath is plotted against their respective propagation delays.

To measure the PDP, one approach is to transmit a known signal and then correlate the received signal with a replica of the transmitted signal at different time offsets. This correlation process yields the channel impulse response, which represents the response of the channel to an impulse-like input. The square of the magnitude of the impulse response provides the power delay profile.

PDP comprises a list of measurements where each measurement contains the information of: (a) delay and (b) power.

Delay profile (DP) represents a degenerated version of the PDP in that it does not comprise power delay information. DP provides information about the delay, time dispersions, multipath components, and fading effects experienced by the transmitted signal. DP comprises a list of measurements where each measurement contains the information of: (a) delay.

In the existing proposal on DP, the reporting is performed as follows.

First, the PDP is evaluated at the UE. A threshold (referred to herein as a “preconfigured threshold”) can be used to determine all of the channel taps (e.g., all of the measured samples) that are xdB below the maximum channel tap. This may help to ensure that only stronger taps are used to determine the position of UE. The taps that fall within the threshold are known as “valid taps”, and correspond to the taps that are to be reported by the UE to the network.

Second, upon determining the valid taps, a bit map of length equal to the number of taps used is created with all zeros. The length can be configured by the LMF or can be agreed between the LMF and the UE/gNB.

Third, in the bitmap, ones are introduced into those corresponding locations that have their associated channel power higher than the estimated threshold. Stated differently, the bitmap is modified such that the valid taps are represented as a “1” and the remaining taps are represented as a “0”. This information is then fed back to the LMF, which uses the bitmap as a model input for the AI/ML model for estimating the position. Consequently, when there are Nₜ taps in the PDP estimate, a DP reporting bitmap of length Nₜ is transmitted to the LMF for use in the model.

Stated differently, for DP reporting, only those taps that cross a preconfigured threshold is represented as a one in the bitmap provided to the LMF. For example, if the number of channel taps, which is typically less than the cyclic prefix (CP), has 256 samples, then a DP report comprises a 256-bit sequence with ones in those points that has a channel strength greater than the preconfigured threshold. Thus, even when there are fewer valid taps, a maximum 256-bit length sequence that maps to the locations having a valid peak that crosses the preconfigured threshold may be transmitted. Optionally, the maximum number of reported can be set to another number (e.g., 128 or 64), which can reduce the maximum number of bits used for reporting. However, this reduction would correspond to a truncation in reported values, and so some information may be lost.

Whether or not the CIR, PDP, and/or DP are used for location positioning may be based on their performance impact and associated signaling overhead for using the new measurement (e.g., CIR/PDP/DP).

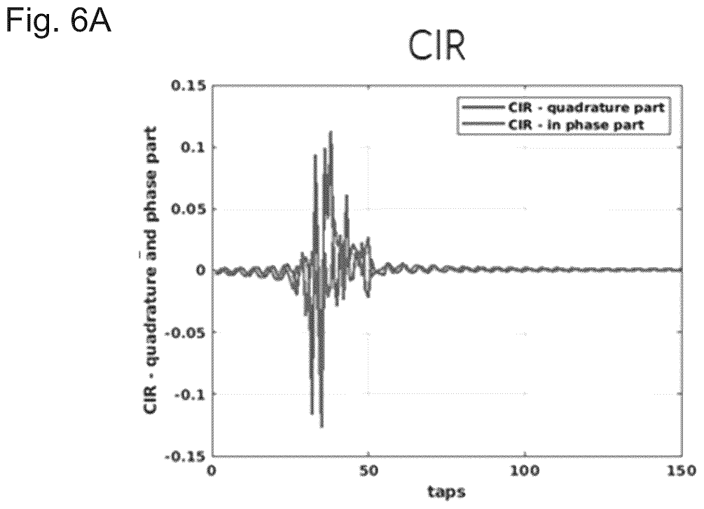

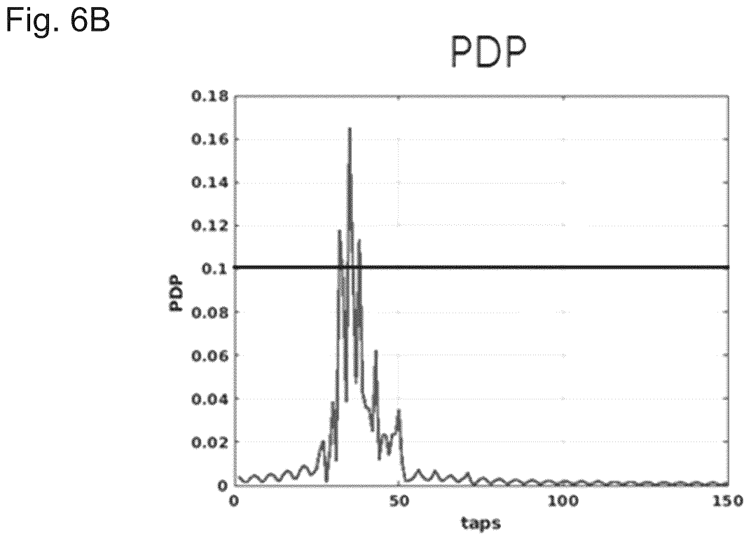

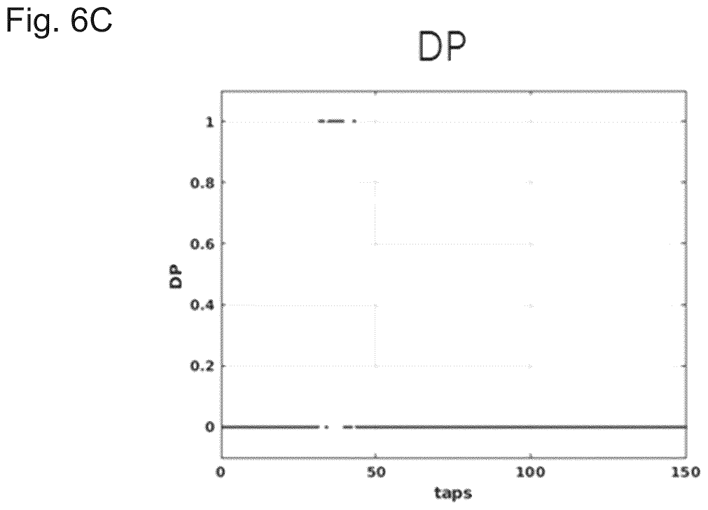

FIGS. 6A to 6C respectively illustrate an amount of overhead in the channel state information (CSI) that may be attributable to each of CIR, PDP, and DP over an increasing number of taps.

As illustrated by these Figures, CIR incurs the highest overhead, which is followed by the PDP and then DP. This is because, in CIR reporting, the time domain channel observed by the UE or gNB is fed back to the LMF with both phase and amplitude information. On the contrary, in PDP reporting, only amplitude information is fed back to the LMF, thus reducing the overhead relative to CIR reporting. Unlike PDP and CIR, DP provides only the dominant channel tap location without providing additional power and/or phase information, which reduces the CSI overhead relative to PDP and/or CIR reporting whilst keeping the same power level for all the valid channel taps.

Stated differently, considering CIR, PDP, and DP, for a given set of parameters (e.g., number of transmission reception points, number of ports, number of time domain samples, etc.):
CIR has the largest measurement size, where CIR is composed of a list of measurements where each measurement contains the information of: (a) delay, (b) power and (c) phase;
PDP has smaller measurement size than CIR, where PDP is composed of a list of measurements where each measurement contains the information of: (a) delay and (b) power; and
DP has the smallest measurement size, where DP is composed of a list of measurements where each measurement contains the information of: (a) delay.

TR 38.843, Section 6.2.4, considered how a reduction in the number of evaluations used as an input to the trained AI/ML model impacted the positioning accuracy.

For example, for the evaluation of direct AI/ML positioning, with Nt consecutive time domain samples used as model input, evaluation results show that when CIR, PDP, or DP is used as model input, using different Nt while holding other parameters the same,
Reducing Nt from 256 to 128 does not appreciably degrade the positioning accuracy, while the measurement size and signaling overhead shrink to (approximately) ½ that of Nt=256.
Positioning error of Nt=128 is 0.81˜1.19 times the positioning error of Nt=256;
Reducing Nt from 256 to 64˜32 may degrade the positioning accuracy, while the measurement size and signaling overhead shrink to (approximately) ¼˜⅛ that of Nt=256, respectively.
Positioning error of Nt=64 is 0.88˜3.00 times the positioning error of Nt=256;
Positioning error of Nt=32 is 1.05˜4.29 times the positioning error of Nt=256;

where the variation in the positioning accuracy depends on AI/ML model complexity.

For direct AI/ML positioning, the evaluation of positioning accuracy at model inference is affected by the type of model input and AI/ML complexity. For a given AI/ML model design, there is a tradeoff between model input, AI/ML complexity (model complexity and computational complexity), and positioning accuracy.

There are not currently any defined procedures and/or signaling that specify how channel state information (such as, for example, CIR/PDP/DP) can be delivered from the UE to network. The CIRs and PDPs are often truncated after a certain number of taps (where the number may be determined based on the specific sampling rates used and the intended uses cases). However, such transactions can be challenging and result in loss of information.

In more detail, transaction-based approaches that truncate data being reported after a certain number of taps are good for saving network resources (as it limits the overhead used for signalling). However, the heuristic nature of these approaches (e.g., in determining which thresholds are to be applied) are difficult to define due to dynamic nature of radio channel. It may therefore be difficult to determine, for different cases, how the network configures UE for transmission of the channel related information, how the UE can select appropriate window and corresponding energy for reporting the channel related information, and whether the LMF can consider UE capability (antenna ports, bandwidth) to define the reporting configuration.

3GPP considered the use of heuristic approaches and on the concept of code books to handle large measurement reporting by quantising the reporting entries while minimizing the quantization loss. In more detail, 3GPP considered configuring the LMF to select a quantization codebook for use in communicating measurement values from a reporting apparatus (e.g., a UE and/or gNB) to the LMF.

In contrast to the previously considered approaches, the following proposes giving flexibility to a reporting apparatus (e.g., a UE and/or an access network node) to adjust and configure an appropriate reporting configuration based on instantaneous channel conditions. Specifically, the following discussed mechanisms provide a trade-off between overhead and complexity using window-specific energy reporting.

In more detail, a reporting apparatus determines whether there are clusters in the DP report in which there are a large number of consecutive zeros (e.g., a large number of taps that were not considered to fall within a threshold amount of the maximum tap value). Gaps between these large numbers of zeros are termed as “windows” in the following. Each window comprises at least two non-zero entries (e.g., each window comprises at least two valid taps). The reporting apparatus creates a bit map for each window that indicates, for that window, the location of the valid taps within the window, relative to the start of the window. The reporting apparatus may provide, for each window, an indication of the location of the window within the time duration over which the measurements were performed and may additionally provide a respective window size when window size is not pre-defined. Stated differently, the reporting apparatus may provide an offset that represents a location of the start of the window relative to a predefined start point, and may additionally provide a respective size of that window. The choice and size of the window may be based on the capability of the reporting apparatus and observed RF conditions.

As such, the following describes at least one procedure for the UE that are used to report the channel related information when the channel related information is to be used as at least one input for AI/ML models running at the network side, such that appropriate reporting configuration can be adapted based on the UE capability and available bandwidth.

Stated differently, the following relates to a UE and/or access network node that can dynamically adapt the reporting configuration based on the observed channel. The reporting configuration adapted by the UE and/or access network node may be adapted and/or selected from a reporting configuration provided to that entity by an LMF. The provided reporting configuration may comprise information indicating maximum and/or minimum values of parameters that may be used for the reporting configuration actually used by the UE and/or access network node. There is therefore provided an efficient procedure to report the delay profile information such that variable numbers of overhead bits can be used for reporting the channel status information. This may result in fewer bits being transmitted relative to current procedures.

In more detail, the following proposes an approach that enables a reduction in overhead resulting from reporting by selecting and reporting valid taps that are present in multiple windows over which the DP is performed. This may reduce the overhead significantly compared to existing DP reporting schemes. Furthermore, the following discloses that power observed over each window may be reported to improve the estimation performance.

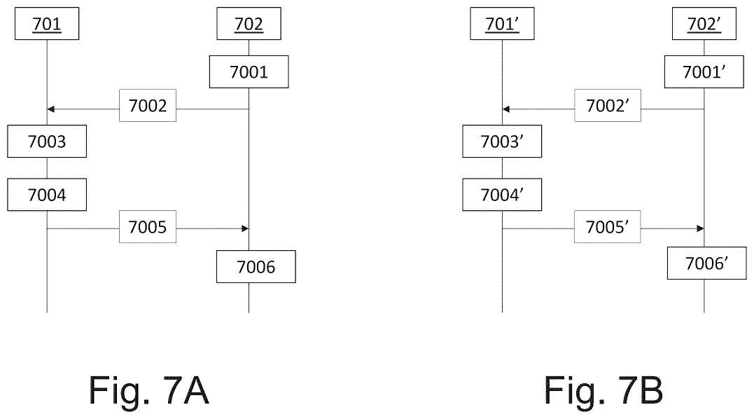

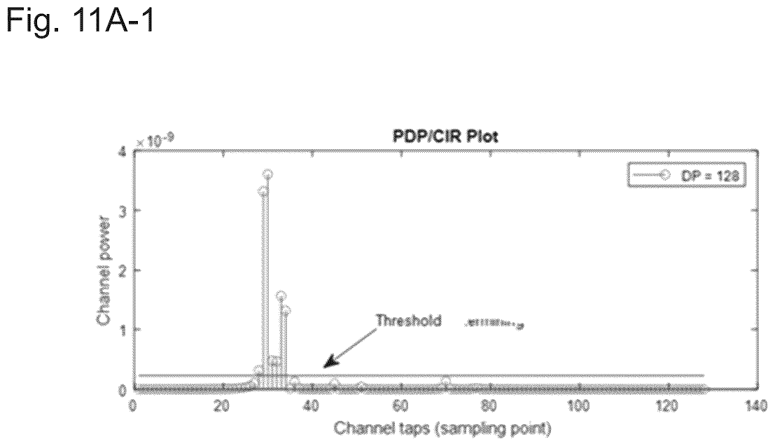

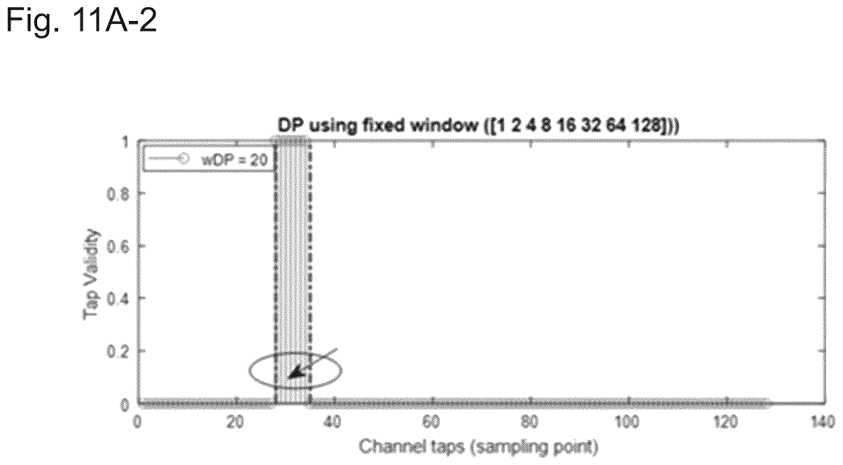

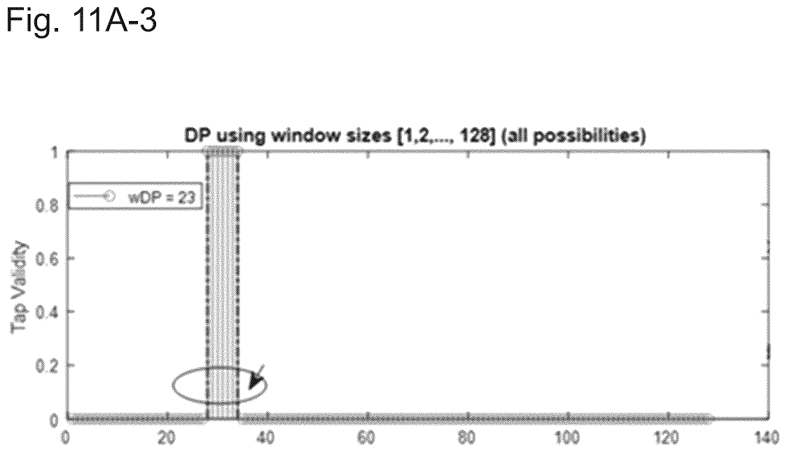

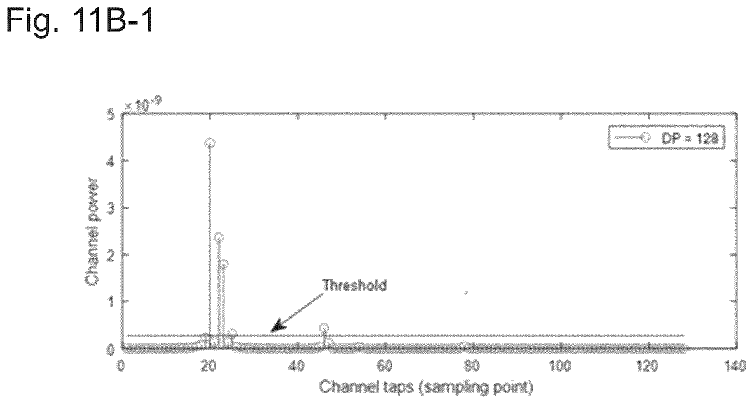

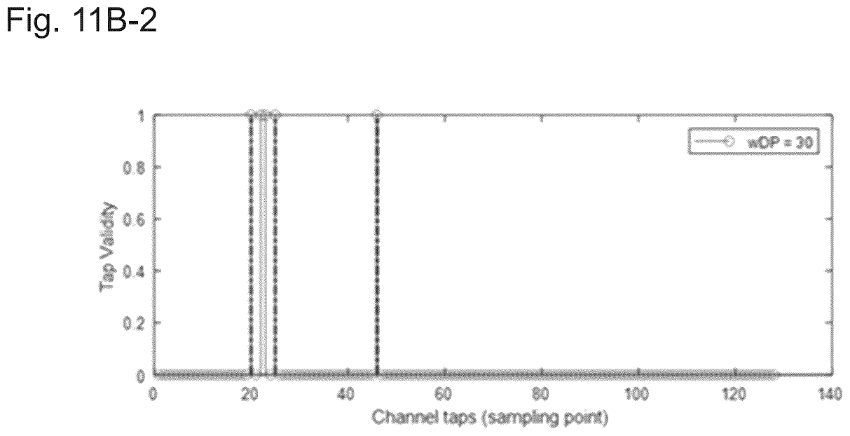

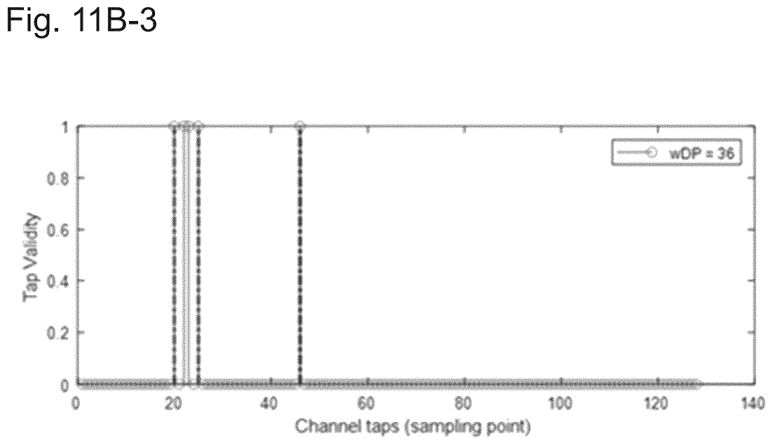

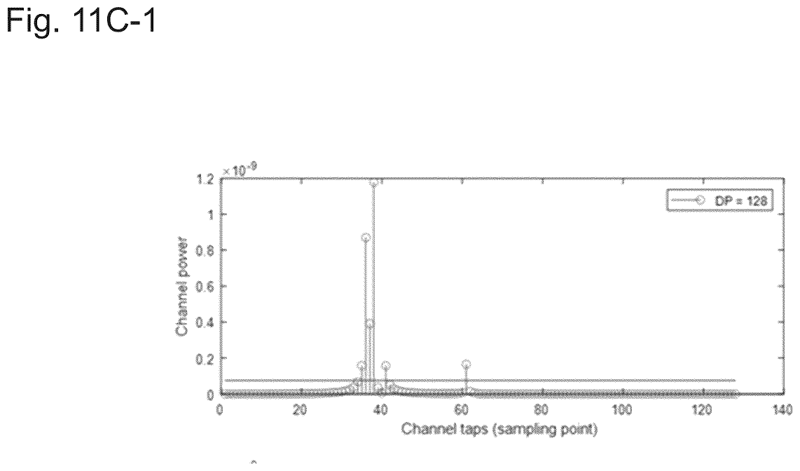

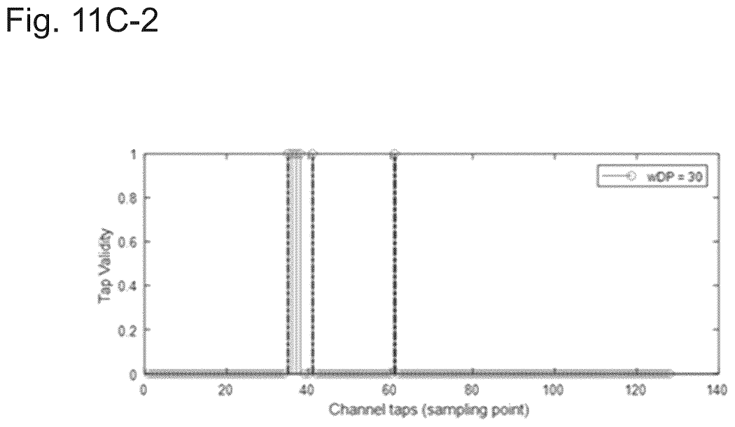

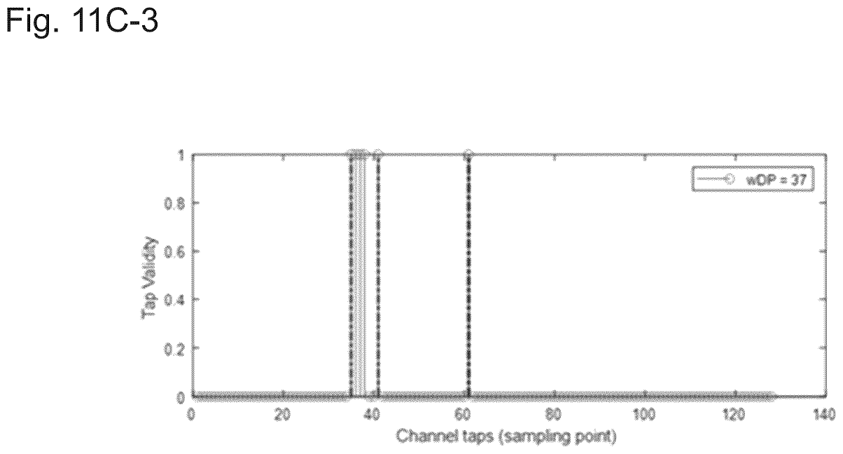

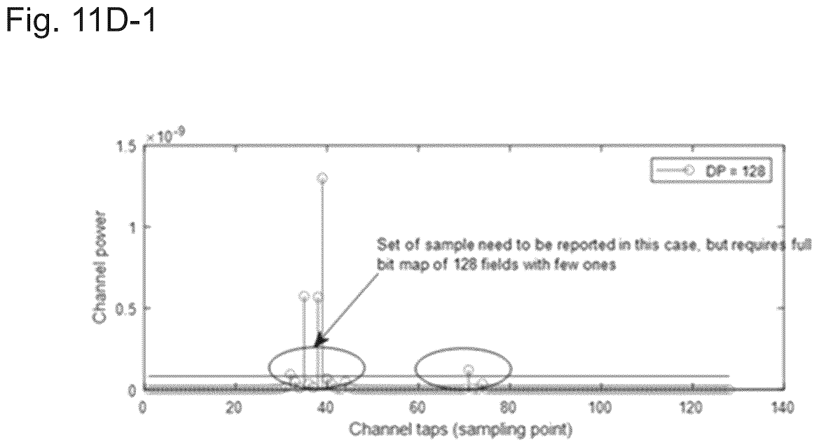

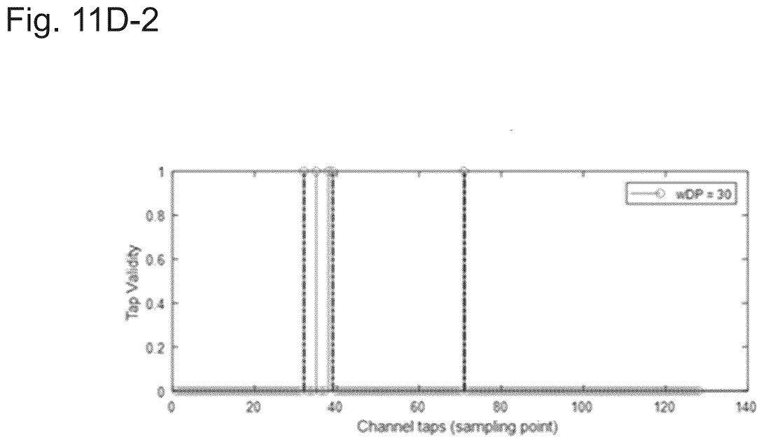

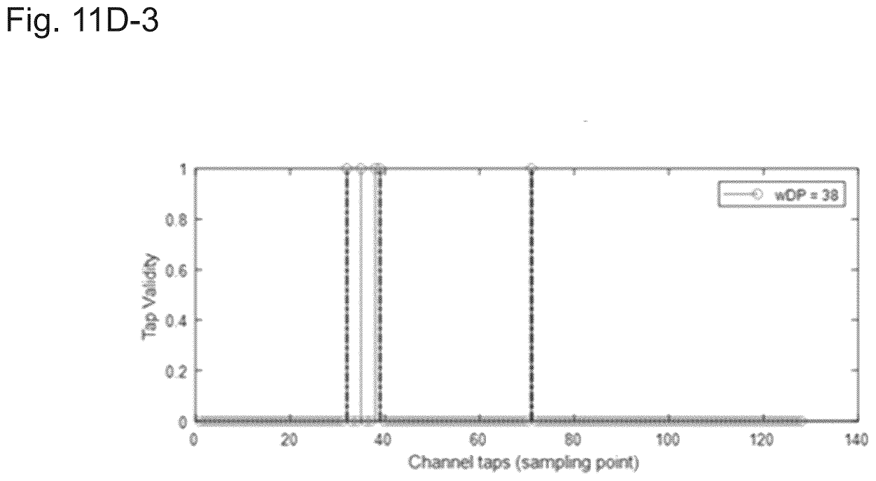

This is illustrated with respect to FIGS. 7A to 13.

In the example of FIG. 7A, an AI/ML model is running at the network side (e.g., at the LMF), and uses channel data (e.g., CIR/PDP/DP) for the purpose of training the model or inference.

FIG. 7A illustrates signalling that may be performed between a UE 701 and an LMF 702.

During 7001, the LMF 701 determines a measurement reporting configuration to be applied by the UE 702.

The measurement reporting configuration may comprise, for example, a measurement window size, and/or a maximum number of measurement windows. The measurement reporting configuration may be based on the UE capability and/or UE bandwidth.

The LMF may configure different levels of reporting based on the UE capability (such as, for example, a number of ports available for use by the UE), and provide possible list of reporting configuration for common CIR/PDP/DP profile/port specific/all port reporting.

The LMF may configure the UE's periodicity of reporting (e.g., aperiodic/semi-persistent/on-demand etc.).

The following discusses several reporting structures for reporting delay profile information from the UE to the LMF. In contrast to the above-mentioned examples, the presenting described reporting structures do not use a bit pattern to indicate the location of taps that crosses certain threshold. The following describes parameters that are common to all of the described reporting structures.
N_{W} is the number of bits, which limits the number of windows used for the reporting procedure.
Wᵢ is the window size, e.g., the size of the DP bit string comprising 1s and 0s that indicate when a measured sample has crossed (or is within) a certain threshold (such as, for example, being within x dB of a maximum sample value, and/or being within y dB of an average sample value).
The length of the window can be from a fixed set, say, [symbol] ∈{1, 2, 4, 8, 16, 32, 64, 128, . . . }, where the choice of window requires log₂ | [symbol] | bits.
Alternatively, any size for window can be used, e.g., [symbol] ∈{1, 2, 3, . . . , Nₜ}, which uses log₂ Nₜ bits to inform the window length.
Oᵢ=log₂ Nₜ bits are used to report the offset from which the window is applied.
σᵢ² corresponds to total energy observed in the CIR within the window defined by Wᵢ

In a first reporting structure, it is assumed that N_{W}=2 windows are used to report the DP. In this reporting structure, the entity that creates the DP information can choose either one or two windows to report the information of the DP. Therefore indicating the number of windows, which is either 0 or 1, uses 1 bit, wherein one being two windows and zero being one window.

The window sizes can be chosen arbitrarily from a fixed set of values, which can either agreed or signaled between the LMF and gNB or UE. The list can, for example, [symbol] ∈{1, 2, 4, 8, 16, 32, 64, 128, . . . } or [symbol] ∈{1, 2, 3, 4, . . . , 128, . . . , Nₜ}, which each use log₂ | [symbol] | bits for reporting.

Therefore, upon having the list of possible windows at the gNB or UE, the DP profile is created at the generation entity (e.g., the UE), using the positioning reference signal as the input for CIR generation, which is used for creating delay profile information.

The choice of windows selected by the UE or gNB can be indicated to the LMF 702 using B_{W}=log₂| [symbol] | bits. Thus, to report the DP using the windowed scheme, following approach can be performed.

First, the UE uses a PRS to obtain the CIR/PDP estimate.

Second, using the estimated CIR/PDP, the UE determines a DP pattern using the preconfigured threshold. The DP pattern comprises a bit string of length Nₜ with ones and zeros, as discussed above.

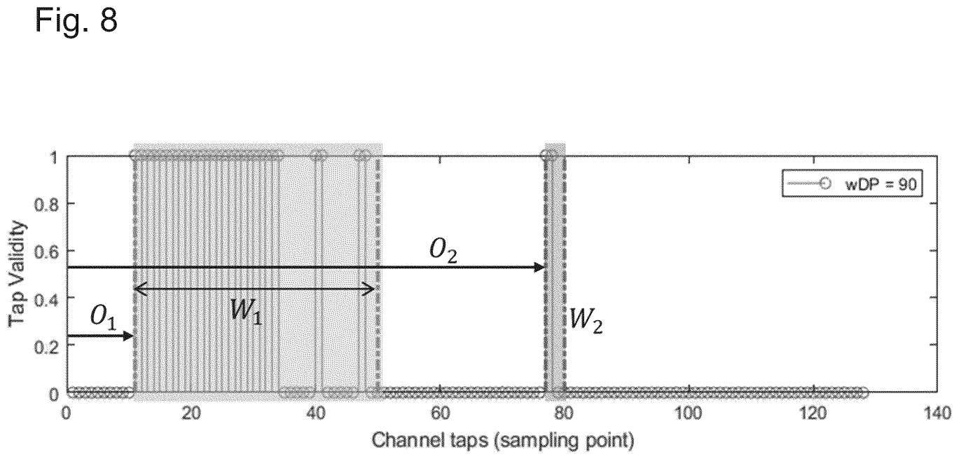

Third, the entity creating the DP pattern uses the first valid bit (e.g., “1”) to determine the location of the first window. The start of the first window is located an offset number of taps from the start of the sampling period. This is illustrated as 0₁ in FIG. 8. The first window is labelled as w₁ in FIG. 8, and has a width of a number of taps. Initially, the entity creating the DP pattern determines whether it is efficient to group all of the valid taps within a single window (e.g., because they are clustered relatively closely together). When it is determined that it is efficient to group all of the taps together, the entity creating the DP pattern defines a single window. When it is determined that it is inefficient to group all of the valid taps together, the entity creating the DP pattern determines whether it is efficient to group all of the valid taps into two windows.

Stated differently, the entity creating the DP pattern (e.g., the UE), may proceed with identifying the second offset (which is illustrated as O₂ in FIG. 8) to check for another possible window.

By assuming two windows, the DP information can be provided using a reduced number of bits relative to present reporting schemes.

An example of the use of two windows is illustrated in FIG. 8, where the first window is located at an offset of 0₁ from the start of the sampling period and has a width of w₁ taps, while the second window is located at an offset of 0₂ from the start of the sampling period and has a width of w₂ taps.

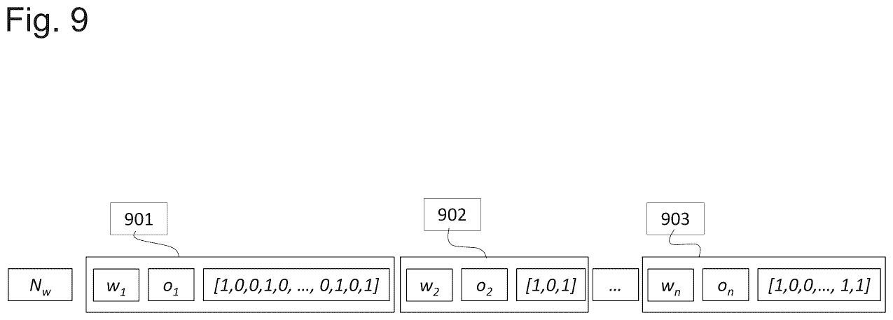

An example of how the windowed DP may be reported to the LMF is illustrated in FIG. 9, in which N_{w} represents a value indicating a number of windows that is comprised in the signalling of FIG. 9.

The information for reporting the first window is indicated at 901. This first window information 901 comprises an indication of the first offset 0₁ (e.g., the starting location of the first window in a number of taps from the first tap associated with the sampling period being reported), an indication of the first window width w₁ (in number of taps), and a data pattern ([1, 0, 0, 1, 0, . . . ]) that identifies, within only the first window, the location of the valid taps comprised in the first window. For example, the first offset, which will be reported to the LMF, uses log₂ Nₜ bits to report. The first window width can be reported using a window index used from the list W, thus using B_{W} bits to report the window index value that represents the length of window used for the first window (e.g., the length of the data pattern). Then the bit pattern of length indicated by index value B_{W} will be used to determine a validity of each bit within the window duration.

Similarly, the information for reporting the second window is indicated at 902. This second window information 902 comprises an indication of the second offset 0₂ (e.g., the starting location of the second window in a number of taps from the first tap associated with the sampling period being reported), an indication of the second window width w₂ (in number of taps), and a data pattern ([1,0,1]) that identifies, within only the second window, the location of the valid taps comprised in the second window.

More information may be added depending on the number of windows determined to be used. For example, the information for reporting the nth window is indicated at 903. This nth window information 903 comprises an indication of the second offset 0ₙ (e.g., the starting location of the second window in a number of taps from the first tap associated with the sampling period being reported), an indication of the second window width wₙ (in number of taps), and a data pattern ([1, 0, 0, . . . ]) that identifies, within only the second window, the location of the valid taps comprised in the second window.

The total number of bits used by the windowed DP for “i∈{1, 2, . . . , N_{W}}” number of windows can be computed as follows.

$${log}_{2} {N}_{W} + {\sum }_{i} {B}_{W} + {log}_{2} \vert 𝒲 \vert + {log}_{2} {N}_{t}$$

The maximum of this total number is comparable to the conventional DP reporting value in the worst case. However, this total number may be significantly less than the DP overhead of Nₜ bits.

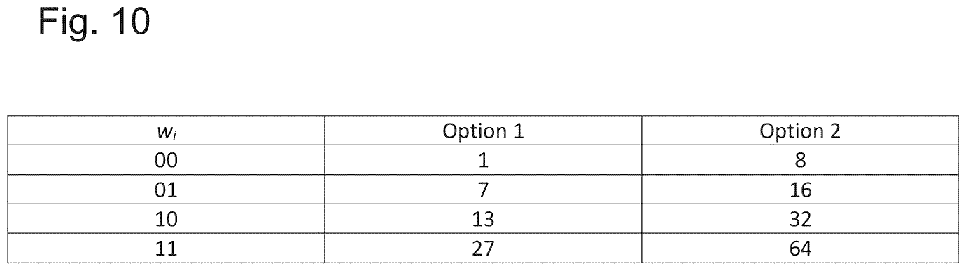

The list of possible windows can be preconfigured at the UE, or signaled in a look-up table (LUT). An example LUT is illustrated in FIG. 10.

FIGS. 11A-1, 11A-2, 11A-3, 11B-1, 11B-2, 11B-3, 11C-1, 11C-2, 11C-3, 11D-1, 11D-2, and 11D-3 illustrate how PDP may be represented as DP using different window sizes.

For example, FIGS. 11A-1, 11A-2, and 11A-3 illustrates 3 graphs. The first graph shows the PDP (or CIR) graph/measurement values that is to be converted into DP. The second graph shows a DP plot using window sizes selected from the selected window sizes of the set {1,2,4,8,16,32,64, 218}. It is understood that any predefined window sizes may be used. The third graph shows a DP plot using any window size (e.g., from 1 to 128 in the present example.

As another example, FIGS. 11B-1, 11B-2, and 11B-3 illustrates 3 graphs. The first graph shows the PDP (or CIR) graph/measurement values that is to be converted into DP. The second graph shows a DP plot using two windows of window sizes selected from the selected window sizes of the set {1,2,4,8,16,32,64, 218}. It is understood that any predefined window sizes may be used. The third graph shows a DP plot using two windows selected from any window size (e.g., from 1 to 128 in the present example.

As another example, FIGS. 11C-1, 11C-2, and 11C-3 illustrates 3 graphs. The first graph shows the PDP (or CIR) graph/measurement values that is to be converted into DP. The second graph shows a DP plot using two windows of window sizes selected from the selected window sizes of the set {1,2,4,8,16,32,64, 218}. It is understood that any predefined window sizes may be used. The third graph shows a DP plot using two windows selected from any window size (e.g., from 1 to 128 in the present example.

As another example, FIGS. 11D-1, 11D-2, and 11D-3 illustrates 3 graphs. The first graph shows the PDP (or CIR) graph/measurement values that is to be converted into DP. The second graph shows a DP plot using two windows of window sizes selected from the selected window sizes of the set {1,2,4,8,16,32,64, 218}. It is understood that any predefined window sizes may be used. The third graph shows a DP plot using two windows selected from any window size (e.g., from 1 to 128 in the present example.

Comparing FIGS. 11A-1, 11A-2, 11A-3, 11B-1, 11B-2, 11B-3, 11C-1, 11C-2, 11C-3, 11D-1, 11D-2, and 11D-3, the fixed window sizes with eight different window size options versus all combinations yields different numbers of overhead bits for communicating the combination of window size and valid taps. The fixed version uses 3 bits to inform the window size, which are limited in the present example to only 8 options. On the contrary, the variable window size option, which uses 128 (Nₜ) different options for window size, has better coverage with higher overhead to report the window size used, e.g., log₂ Nₜ bits. The number of overhead bits may be different in different cases (for example, fixed window sizes may be determined to be better in few cases compared to the variable window sizes, and vice versa in other cases).

Once the network or LMF configures the maximum number of windows to be used, the UE or gNB is not mandated to use the maximum number of configured windows. Depending on the overhead reduction, the UE or gNB can arbitrarily choose the number of windows for reporting. An exhaustive search can also be used to determine the best combination of window sizes and the number of windows for reporting.

Thus in FIGS. 11A-1, 11A-2, 11A-3, 11B-1, 11B-2, 11B-3, 11C-1, 11C-2, 11C-3, 11D-1, 11D-2, and 11D-3, it is seen that there is reduction in the number of bits used to report the same delay profile to the LMF by the generating entity, which is either UE or gNB. The overall reduction in the number of bits entirely depends on the number of window sizes provided by the LMF for selection.

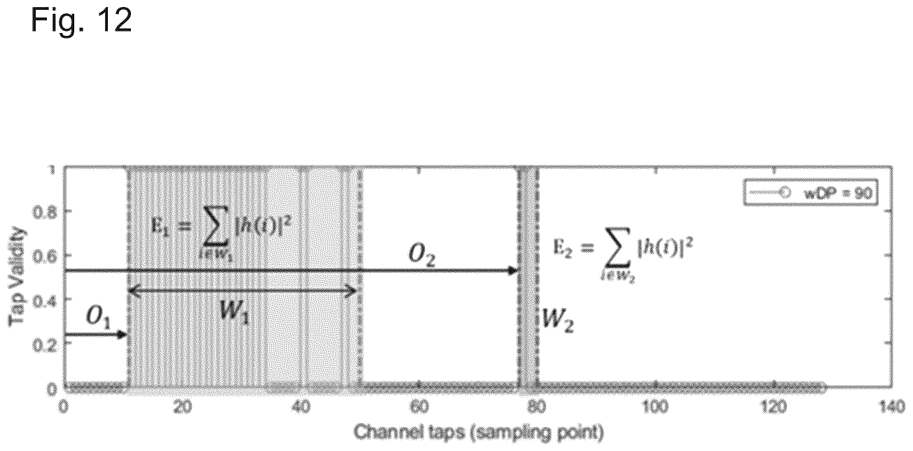

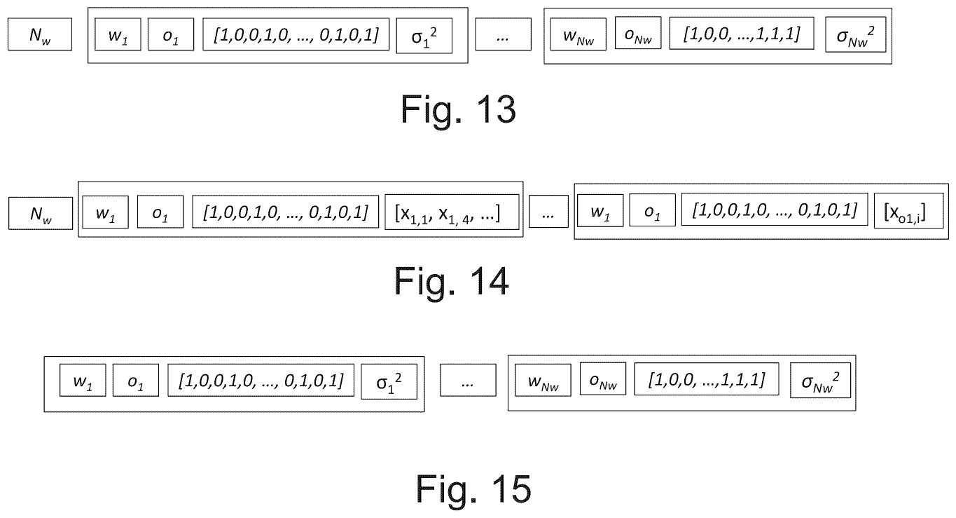

Another reporting structure is illustrated with respect to FIGS. 12 to 13.

In this example of FIGS. 12 to 13, quantized power level of the channel taps within each window is provided by the UE to improve the reconstruction at the LMF side for model input. For example, a window-specific total channel tap power may be provided. Consequently, the feedback entity (e.g., the UE in the present example) may additionally provide information on the total energy observed within a window to assist the LMF sided model for better estimation accuracy.

This proposed approach reduces the overall feedback bits without compromising on the performance. The overhead involved in feeding back additional power information to DP increases the overhead significantly, which is scaled by the number of bits used to report the power level, i.e., Nₜ×ρ bits, where ρ denotes the number of bits used to report a power level of a tap. Similar approach can be used in the proposed scheme as well.

FIG. 13 illustrates a reporting structure for DP reporting that comprises the additional window level power illustrated in FIG. 12. In FIG. 13, N_{w} represents a value indicating a number of windows that is comprised in the signalling of FIG. 13.

Relative to FIG. 9, in addition to including information on a window's offset, width, and location of valid taps, the reporting structure in FIG. 13 additionally comprises σ_{Nw}², which indicates, for its respective window, a power level of the taps comprised in the window.

The power level may correspond to a power observed within the respective window. For example, the value of the power level may correspond to a total power evaluated over all of the taps that crosses the threshold within the respective window (e.g., stated differently, the power level may correspond to the sum of a measured power of all of the taps).

As another example, the value of the power value may correspond to an average (e.g., normalized) power of the valid. In this example, the window width (in bit length) may be selected such that the maximum power of taps (whether all of the taps within the window, or only all of the valid taps within the window) does not exceed predetermined value.

FIG. 14 illustrates another example reporting structure. In FIG. 14, N_{w} represents a value indicating a number of windows that is comprised in the signalling of FIG. 14. In the example of FIG. 14, in addition to reporting DP (either with or without σ_{Nw}², not shown), the reporting structure can be used to also provide CIR and/or PDP feedback as well (e.g., phase and/o/or amplitude of the valid taps). In the example of FIG. 14, x_{i,j} represents either to a power or the channel tap observations within window i and a valid sample j within window i. As shown in this Figure, as the location of the valid taps is already included in the reporting structure, results falling below the threshold used for identifying the valid taps are not transmitted.

FIG. 15 illustrates another example reporting structure. In this example of FIG. 15, the LMF can enforce the number of windows to be used for reporting and UE uses the fixed number of windows configured by the LMF for reporting. However, the size of each window can be decided by the UE or gNB. The size of the window may be based on, for example, an energy concentration of CIR/PDP profile (e.g., so that window specific energy reporting can benefit the model inference at LMF), and/or based on reducing overhead involved in the reporting. This example of FIG. 15 differs from the example of FIG. 13 in that FIG. 15 uses a fixed number of windows while FIG. 13 does not use a fixed number of windows (e.g., FIG. 13 relates to an example of a variable number of windows). This means that the signalling of FIG. 15 does not comprise a value for N_{w}.

The choice of reporting may therefore be performed by the UE depending on the channel conditions, as illustrated in FIG. 15.

During 7002, the LMF 702 signals the UE 701. This signaling may comprise a request for the UE to perform a measurement to obtain a measurement result that can be used to determine a location of the UE 701 (where a measurement result can be used to determine a location of the UE 701 when the LMF is configured to use that measurement result to determine the location of the UE). The request may be comprised in a location positioning protocol (LPP) message that comprises the reporting configuration determined during 7001. The UE may be configured to select at least one configuration for reporting the measurement result based on current network con to the UE to select the appropriate setting reflecting the UE and RF conditions. The reporting configuration can also be part of functionality-based life-cycle management (LCM). Functionality-based LCM is a framework used to deal with LCM operations for AI/ML-controlled air interface mechanisms, such as monitoring and inference. Stated differently, functionality-based LCM refers to those configurations facilitated by an AI/ML-functionality.

Stated differently, during 7002, the LMF 702 signals to the UE 701 a request for the UE to select a window, and shares window configurations for reporting at least one of CIR, PDP and/or DP.

During 7003, the UE performs and computes layer 1 (e.g., physical layer) measurements on a received reference signal from a network access node (e.g., a PRS). The UE 701 process at least one of the CIR, PDP, and/or DP based on the measurement results obtained from these measurement computations.

During 7004, the UE 701 determines (e.g., selects) a window size for reporting the measurement results (e.g., CIR, PDP, and/or DP) of 7003. This selection may be based on the information provided during 7002.

The UE may select a respective threshold for each window to determine the DP profile and corresponding total power based on the usefulness of the channel taps. The threshold can be window specific, which alters the DP profile within each window.

The UE may determine a window by implementing a windowing algorithm. The UE may implement the windowing algorithm as follows.

First, the UE estimates the CIR/PDP using a positioning reference signal.

Second, the UE applies the threshold based on certain conditions, such as, xdB below the maximum tap or ydB above the average channel energy.

Third, the UE generates a DP report (expressed as d) with ones in the DP report corresponding to those sample points that cross the threshold, and the rest of the rest of the bits in the report being set to zero.

Fourth, edges and isolated points are obtained by performing double differential operation on the DP report. An “edge” may be considered to be a potential start and/or end location of a window. For example, a window “011111000” after filter “−1,−1,1,0,0,0,0,0,1,−1,0,0” is applied) An “isolated point” may be considered to comprise a bit value of “1” that is surrounded by bit values of “0”. Stated differently, an isolated point may comprise a tap that crosses the threshold (e.g., that is a valid tap) that does not have any adjacent valid taps. For example, “0001000” after filter “0,0,0,−1,2,−1,0,0,0” is applied. This may be performed numerically by, for example, by convolving the DP report with the filter g=[−1,2,−1]. The resultant output of this filter, say f=d*g, has the following behavior:
a. f==2 represents isolated points.
b. f==1 denotes the edge points.

Thus, f==1 may be marked as edges that are transition points.

When the count of the transition points is odd, an additional “0” may be comprised in the DP reporting array, and/or adjacent pair of values may be treated as one block of contiguous “1”.

Using both edge points and isolated points, possible window locations may be determined. The possible window locations may then be analysed to select a window configuration (and hence a DP reporting configuration) to be used for reporting the DP values. Stated differently, the identified edge points and isolated points are used to perform an exhaustive search over possible window options can be used to determine the DP reporting configurations.

During 7005, the UE 701 signals the LMF 702. This signalling may comprise the measurement results to be reported (e.g., CIR, PDP, and/or DP) using the selected window of 7004 and the reporting configuration of 7002. The signalling may be performed using the LPP signalling.

In a variation to 7005, during 7005 instead of reporting the measurements with a variable number of windows that is less than the maximum requested windows, the UE may report using the maximum requested windows to LMF.

During 7006, the LMF 702 uses the information signalled during 7005 to reconstruct at least one of CIR, PDP, and/or DP using the selected reporting configuration for the model input. The reconstructing at least one of the CIR and/or PDP and/or DP to use as the input may ensure that the same type (and size) of input is consistently used as an input to that AI/ML model.

FIG. 7B illustrates another example in which an AI/ML model is running at the network side (e.g., at the LMF), and uses channel data (e.g., CIR/PDP/DP) for the propose of training the model or inference from a network access node 701′ (e.g., a gNB).

FIG. 7B illustrates signalling that may be performed between a network access node 701′ and an LMF 702′.

During 7001′, the LMF 702′ determines a measurement reporting configuration to be applied by the network access node 702′. This may as described above in relation to the UE of FIG. 7A, where references to the UE are replaced by the network access node, and references to a PRS are replaced by a sounding reference signal that is transmitted by a UE whose location is to be determined.

During 7002′, the LMF 702′ signals the network access node 701′. This signaling may comprise a request for the network access node to perform a measurement to obtain a measurement result that can be used to determine a location of the network access node 701′ (where a measurement result can be used to determine a location of the network access node 701′ when the LMF is configured to use that measurement result to determine the location of the network access node). The request may be comprised in a new radio positioning protocol A (NRPPa) message that comprises the reporting configuration determined during 7001′. The network access node may be configured to select at least one configuration for reporting the measurement result based on current network con to the network access node to select the appropriate setting reflecting the network access node and RF conditions.

Stated differently, during 7002′, the LMF 702′ signals to the network access node 701′ a request for the network access node to select a window, and shares window configurations for reporting at least one of CIR, PDP and/or DP.

During 7003′, the network access node performs and computes layer 1 (e.g., physical layer) measurements on a received reference signal from a network access node (e.g., a PRS). The network access node 701′ process at least one of the CIR, PDP, and/or DP based on the measurement results obtained from these measurement computations.

During 7004′, the network access node 701′ determines (e.g., selects) a window size for reporting the measurement results (e.g., CIR, PDP, and/or DP) of 7003′. This selection may be based on the information provided during 7002′.

The network access node may select a respective threshold for each window to determine the DP profile and corresponding total power based on the usefulness of the channel taps. The threshold can be window specific, which alters the DP profile within each window.

During 7005′, the network access node 701′ signals the LMF 702′. This signalling may comprise the measurement results to be reported (e.g., CIR, PDP, and/or DP) using the selected window of 7004′ and the reporting configuration of 7002′. The signalling may be performed using the NRPPa protocol.

In a variation to 7005′, during 7005′ instead of reporting the measurements with a variable number of windows that is less than the maximum requested windows, the network access node may report using the maximum requested windows to LMF. This may help ensuring that the reporting overhead from the UE to the LMF is always less or equal to the reporting overhead from the gNB to the LMF.

During 7006′, the LMF 702′ uses the information signalled during 7005′ to reconstruct at least one of CIR, PDP, and/or DP using the selected reporting configuration for the model input. This may be performed for the reasons described above in connection with 7006.

In all of the above examples of FIGS. 7A to 7B, the reporting structure may be varied based on the number of ports to be reported.

In more detail, when ports are mapped to multiple antennas (e.g., each port is treated as a beam), then the DP profile (e.g., window start location, window length, etc.) can be different for each port, or the same for two or more ports (e.g., the same for all ports). For example, each port (e.g., each beam) may have a DP reporting profile that is determined independently of the determination(s) of a DP reporting profile for the other ports. As another example, at least two ports (e.g., all ports) may have the same DP reporting profile that is determined in dependence on each other.

When ports are mapped to only one antenna, then the DP profile can be common for all antennas, as they are spatially correlated. In this case, only the energy seen by each antenna can be provide as a separate entity.

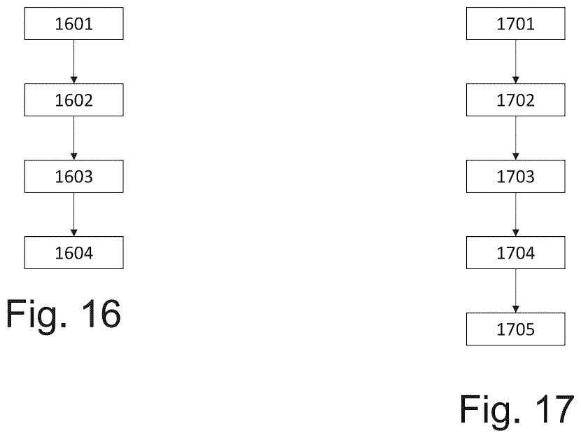

Features of the above examples are illustrated below with respect to FIGS. 16 to 17. It is therefore understood that the following features may find functional correspondence with features mentioned above, especially where the same terminology is used.

FIG. 16 illustrates operations that may be performed by an apparatus for a location management function (LMF). The apparatus may be comprised as a function in the 5G core network. The apparatus may be comprised as part of the access network node (e.g., a gNB). The apparatus may be as described above in connection with FIG. 2.

During 1601, the apparatus determines, based on at least one condition of a reporting apparatus, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps. The reporting apparatus may be the reporting apparatus of FIG. 17.

A tap (including a valid tap) may be as described above. For example, a tap may be considered to be a representation of delay and/or attenuation on time domain of at least one of CIR, PDP, or DP as a consequence of distortion due to effects of surrounding objects and mobility. A valid tap may correspond to a measured sample that lies within xdB of a maximum sample value, or within ydB of average energy of channel.

The window may be as described above in connection with the examples. For example, a single window may represent a time interval that is less than a specific measurement interval (e.g. less than a specified time duration in which measurements are performed, where the specified time duration is defined in the first measurement reporting configuration). Stated differently, a single window may correspond to a subsection (e.g., not all) of all of the DP taps identified during the specific measurement interval. Each window comprises at least one valid tap of a DP.

The at least one condition of the reporting apparatus may comprise at least one of: a number of antenna ports, an available bandwidth available to the reporting apparatus (e.g., a bandwidth of a positioning reference signal), a maximum number of taps to be reported by the reporting apparatus, a maximum number of transmission reception points to be reported on by the reporting apparatus, or a type of measurements to be reported (e.g., CIP, PDP, and/or DP).

The determining the first measurement configuration may be based on at least one additional condition that comprises at least one of: a cell identifier to be reported on, a scenario to be reported on, or an indication of a dataset quality to be used for training. Stated differently, the determining the first measurement configuration may be based on a condition of the UE (such as discussed in the previous paragraph) and an additional condition (e.g., based on a characteristic of data to be input the AI/ML model). Stated differently, the condition of the reporting apparatus may correspond to a configuration of the reporting apparatus when the measurements are being performed by the reporting apparatus, while the additional condition may correspond to a characteristic of data to be input to the AL/ML model.

a cell identifier to be reported on, a scenario to be reported on, or an indication of a dataset quality to be used for training.

During 1602, the apparatus signals, to the reporting apparatus, the first measurement reporting configuration and a request for the reporting apparatus to select a second measurement reporting configuration to be used by the reporting apparatus based on the first measurement reporting configuration.

During 1603, the apparatus receives, from the reporting apparatus, a measurement report according to the second measurement reporting configuration.

The measurement report may comprise, for a least one window, a bit string identifying valid taps of DP for that window. The measurement report may comprise, for each of said at least one window, an indication of a length of said window, and/or an indication of a power and/or energy associated with the window. Where the first measurement configuration does not comprise a instruction to use a predetermined number of windows, the measurement report may comprise an indication of the number of windows reported in the measurement report.

During 1604, the apparatus uses at least one value comprised in the measurement report as an input to an artificial intelligence and/or machine learning model.

The input to the AI/ML model may be for training the AI/ML model and/or for obtaining an analysis of values comprised in the measurement report (e.g., of values corresponding to a current radio environment of the reporting apparatus), and/or for obtaining a recommendation of an action to be performed based on values comprised in the measurement report (e.g., of values corresponding to a current radio environment of the reporting apparatus).

The using at least one value comprised in the measurement report as an input to an artificial intelligence and/or machine learning model may comprise: identifying, from the received measurement report, the second measurement reporting configuration, reconstructing at least one of a channel impulse response or a power delay profile or a delay profile using the second measurement reporting configuration, and using the reconstructed at least one of a channel impulse response or a power delay profile or a delay profile as an input to the artificial intelligence and/or machine learning model.

The maximum frequency of reporting measurements may define a maximum frequency of periodic measurement reports, and/or a maximum frequency of measurement reports provided according to event-based reporting (e.g., a maximum frequency of aperiodic measurement reports).

The first measurement reporting configuration may configure the reporting apparatus to report measurements periodically and/or using event-based criteria. Event-based criteria may provide criteria that, when fulfilled, cause a measurement report to be provided according to 1603.

The first measurement reporting configuration may comprise a plurality of third measurement reporting configurations, each of said third measurement reporting configurations relating to a respective port.

The first measurement reporting configuration may comprise a plurality of third measurement reporting configurations, the third measurement reporting configurations relating to a same plurality of ports.

The measurement report may comprise an indication of the number of windows used for reporting, and, for each window, a location of a start point for said window, a width of said window, and locations of valid taps within said window.

The measurement report may comprise, for each window, at least one of: phase information of valid taps being reported in said window, amplitude information of valid taps being reported in said window, and/or an energy of valid taps being reported in said window.

The measurement report may further comprise, for each window, an indication of a threshold used for identifying valid taps comprised in said window.

When the reporting apparatus comprises a user equipment, the signalling may be signalled using location positioning protocol signalling.

When the reporting apparatus comprises an access network node, the signalling may be signalled using new radio positioning protocol A.

FIG. 17 illustrates operations that may be performed by an apparatus for a reporting apparatus. The reporting apparatus may comprise a terminal (such as described in connection with FIG. 3). The reporting apparatus may comprise a controller for an access network node (such as a gNB), where the controller may be as described in connection with FIG. 2.

During 1701, the apparatus receives, from a location management function, LMF, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps.

The LMF may be as described above in relation to FIG. 16. The taps (e.g., valid taps) may be as described above in relation to FIG. 16. The window may be as described above in connection with FIG. 16.

The first configuration may be comprised in a specific functionality that comprises a set of configurations that are based on conditions of the reporting apparatus and additional conditions. For example, the conditions of the reporting apparatus may comprise at least one of: a number of antenna ports, an available bandwidth available to the reporting apparatus (e.g., a bandwidth of a positioning reference signal), a maximum number of taps to be reported by the reporting apparatus, a maximum number of transmission reception points to be reported on by the reporting apparatus, or a type of measurements to be reported. The additional conditions may comprise at least one of: a cell identifier to be reported on, a scenario to be reported on, or an indication of a dataset quality to be used for training.

During 1702, the apparatus receives, from the LMF, a request for the reporting apparatus to select a second measurement reporting configuration to be used by the reporting apparatus based on the first measurement reporting configuration.

During 1703, the apparatus selects the second measurement reporting configuration based on the first measurement reporting configuration.

During 1704, the apparatus measures a state of a channel between the reporting apparatus and another apparatus.

During 1705, the apparatus signals, to the LMF, a measurement report according to the second measurement reporting configuration, the measurement report comprising values based on the measured state of the channel.

The maximum frequency of reporting measurements may define a maximum frequency of periodic measurement reports, and/or a maximum frequency of event-based reporting.

The first measurement reporting configuration may configure the reporting apparatus to report measurements periodically and/or using event-based criteria.

The first measurement reporting configuration may comprise a plurality of third measurement reporting configurations, each of said third measurement reporting configurations relating to a respective port, wherein the second measurement reporting configuration is selected from the third measurement configurations based on the port used for channel state measurement.

The first measurement reporting configuration may comprise a plurality of third measurement reporting configurations, the third measurement reporting configurations relating to a same plurality of ports.

The measurement report may comprise an indication of the number of windows used for reporting, and, for each window, a location of a start point for said window, a width of said window, and locations of valid taps within said window.

The measurement report may comprise, for each window, at least one of: phase information of valid taps being reported in said window, amplitude information of valid taps being reported in said window, and/or an energy of valid taps being reported in said window.

The measurement report may comprise, for each window, an indication of a threshold used for identifying valid taps comprised in said window.

When the reporting apparatus comprises a user equipment, the signalling may be performed using location positioning protocol signalling.

When the reporting apparatus comprises an access network node, the signalling may be performed using new radio positioning protocol A signalling.

The second reporting configuration may be selected to comprise a window size that is based on the measured channel state.

The second reporting configuration may be selected to comprise a reporting periodicity that is based on at least one of a capability of the reporting apparatus, a power state of the reporting apparatus, a bandwidth available to the reporting apparatus, and/or a number of ports.

The first reporting configuration may be comprised in specific functionality that comprises a set of configurations comprising at least a condition of the reporting apparatus and/or an additional condition. The condition of the reporting apparatus may relate to a configuration of the reporting apparatus when the measurements are being performed by the reporting apparatus. The additional condition may correspond to a characteristic of data to be input to the AL/ML model.

For example, the at least one condition of the reporting apparatus may comprise at least one of: a number of antenna ports, an available bandwidth available to the reporting apparatus, a maximum number of taps to be reported by the reporting apparatus, a maximum number of transmission reception points to be reported on by the reporting apparatus, or a type of measurements to be reported.

For example, the at least one additional condition that comprises at least one of: a cell identifier to be reported on, a scenario to be reported on, or an indication of a dataset quality to be used for training.

The apparatus may select a threshold amount (x dB) for identifying the valid taps, wherein the valid taps are those sample values that are measured to be within x dB of a maximum sample value.

The apparatus may select a threshold amount (ydB) for identifying the valid taps, wherein the valid taps are those sample values that are measured to be ydB above an average channel energy for the channel whose state is being measured.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus for a location management function, the apparatus comprising:
at least one processor; and
at least one memory having instructions stored thereon that, when executed by the at least one processor, cause the apparatus to at least perform;
determining, based on at least one condition of a reporting apparatus, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps;
signalling, to the reporting apparatus, the first measurement reporting configuration and a request for the reporting apparatus to select a second measurement reporting configuration to be used by the reporting apparatus based on the first measurement reporting configuration;
receiving, from the reporting apparatus, a measurement report according to the second measurement reporting configuration; and
using at least one value comprised in the measurement report as an input to an artificial intelligence and/or machine learning model.

2. An apparatus as claimed in claim 1, wherein the using at least one value comprised in the measurement report as an input to an artificial intelligence and/or machine learning model further comprises performing:
identifying, from the received measurement report, the second measurement reporting configuration;
reconstructing at least one of a channel impulse response or a power delay profile or a delay profile using the second measurement reporting configuration; and
using the reconstructed at least one of a channel impulse response or a power delay profile or a delay profile as an input to the artificial intelligence and/or machine learning model.

3. An apparatus as claimed in claim 1, wherein the maximum frequency of reporting measurements defines a maximum frequency of periodic measurement reports, and/or a maximum frequency of event-based reporting.

4. An apparatus as claimed in claim 1, wherein the first measurement reporting configuration configures the reporting apparatus to report measurements periodically and/or using event-based criteria.

5. An apparatus as claimed in claim 1, wherein the first measurement reporting configuration comprises a plurality of third measurement reporting configurations, each of said third measurement reporting configurations relating to a respective port.

6. An apparatus as claimed in claim 1, wherein the first measurement reporting configuration comprises a plurality of third measurement reporting configurations, the third measurement reporting configurations relating to a same plurality of ports.

7. An apparatus as claimed in claim 1, wherein the measurement report comprises an indication of the number of windows used for reporting, and, for each window, a location of a start point for said window, a width of said window, and locations of valid taps within said window.

8. An apparatus as claimed in claim 7, wherein the measurement report further comprises, for each window, at least one of: phase information of valid taps being reported in said window, amplitude information of valid taps being reported in said window, and/or an energy of valid taps being reported in said window.

9. An apparatus as claimed in claim 1, wherein the measurement report further comprises, for each window, an indication of a threshold used for identifying valid taps comprised in said window.

10. An apparatus as claimed in claim 1, wherein the reporting apparatus comprises a user equipment, and the signalling comprises location positioning protocol signalling.

11. An apparatus as claimed in claim 1, wherein the reporting apparatus comprises an access network node, and the signalling comprises new radio positioning protocol A.

12. An apparatus as claimed in claim 1, wherein the at least one condition of the reporting apparatus comprises at least one of: a number of antenna ports, an available bandwidth available to the reporting apparatus, a maximum number of taps to be reported by the reporting apparatus, a maximum number of transmission reception points to be reported on by the reporting apparatus, a type of measurements to be reported.

13. An apparatus as claimed in claim 1, wherein the determining based on at least one condition of a reporting apparatus further comprises determining based on at least one additional condition that comprises at least one of: a cell identifier to be reported on, a scenario to be reported on, or an indication of a dataset quality to be used for training.

14. A method for an apparatus for a location management function, the method comprising:
determining, based on at least one condition of a reporting apparatus, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps;
signalling, to the reporting apparatus, the first measurement reporting configuration and a request for the reporting apparatus to select a second measurement reporting configuration to be used by the reporting apparatus based on the first measurement reporting configuration;
receiving, from the reporting apparatus, a measurement report according to the second measurement reporting configuration; and
using at least one value comprised in the measurement report as an input to an artificial intelligence and/or machine learning model.

15. A non-transitory computer readable medium comprising instructions which, when executed by a computer for a location management function, LMF, cause the computer to carry out:
determining, based on at least one condition of a reporting apparatus, a first measurement reporting configuration wherein the first measurement reporting configuration comprises at least one of: a list of at least one allowable window size for reporting valid taps, a maximum number of windows for reporting valid taps, or a maximum frequency of reporting measurement information comprising valid taps;
signalling, to the reporting apparatus, the first measurement reporting configuration and a request for the reporting apparatus to select a second measurement reporting configuration to be used by the reporting apparatus based on the first measurement reporting configuration;
receiving, from the reporting apparatus, a measurement report according to the second measurement reporting configuration; and
using at least one value comprised in the measurement report as an input to an artificial intelligence and/or machine learning model.
